(19) United States
(12) Patent Application Publication
(10) Pub. No.: US 2026/0092634 A1
(43) Pub. Date: Apr. 2, 2026

(54) SHOCK ABSORBER AND METHOD FOR ATTACHING A DAMPING FORCE ADJUSTMENT APPARATUS

(71) Applicant: HITACHI ASTEMO, LTD., Ibaraki (JP)

(72) Inventors: Tomohiko IIDA, Ibaraki (JP); Hiroshi YAMAGAI, Ibaraki (JP)

(21) Appl. No.: 19/110,539

(22) PCT Filed: Sep. 5, 2023
(86) PCT No.: PCT/JP2023/032348

§ 371 Date: Mar. 11, 2025

(30) Foreign Application Priority Data
Oct. 18, 2022 (JP) 2022-167233

(51) Int. Cl. F16F 9/46; F16F 9/32

(52) U.S. Cl. CPC F16F 9/465; F16F 9/3271; F16F 2226/04

(57) ABSTRACT

The present invention provides a shock absorber and a method for attaching a damping force adjustment apparatus that allow a tubular body to be crimped with improved flexibility. The present invention lowers the rigidity of an end portion of a valve case by forming a slit (a weakened portion) on the end portion of the valve case (the second tubular body), thereby allowing the end portion of the valve case to be crimped with a further weak crimping force, i.e., bent with a further weak pressing force, thus allowing the valve case (the tubular body) to be crimped with improved flexibility.

### TECHNICAL FIELD

The present invention relates to a shock absorber including a damping force adjustment apparatus that controls a valve-opening pressure of a valve body using an actuator, and a method for attaching such a damping force adjustment apparatus.

### BACKGROUND ART

PTL 1 discloses a damping force adjustable shock absorber 1 (hereinafter referred to as a “conventional shock absorber”) in which a large-diameter portion 50 having a tapered inner peripheral surface gradually increasing in diameter toward a solenoid case 42 is formed on one end portion of a thinned wall portion 47 of a valve case 41.

### CITATION LIST

### Patent Literature

PTL 1: Japanese Patent Application Laid-Open No. 2019-027460

### SUMMARY OF INVENTION

### Technical Problem

According to the conventional shock absorber, a step of attaching a damping force adjustment apparatus is performed in the following manner. When the valve case and the solenoid case are integrated by crimping, a crimped portion is formed by using a tool moving from an opening end side to a proximal end side of the valve case (leftward as viewed in FIG. 2) to press the one end portion of the thinned wall portion of the valve case perpendicularly to the movement direction of the tool to bend it into a crimping groove of the solenoid case.

To ensure sufficient joining strength (strength against separation) between the valve case and the solenoid case, the above-described conventional method has required a strong crimping force corresponding thereto, thereby raising a possibility of deformation of an outer tube due to an increase in a load imposed on the outer tube (an outer cylinder). As a result, this method has necessitated an increase in the plate thickness of the outer tube, leading to a weight increase in the outer tube and thus the shock absorber.

One of the objects of the present invention is to provide a shock absorber and a method for attaching a damping force adjustment apparatus that allow a tubular body to be crimped with improved flexibility.

### Solution to Problem

One aspect of the present invention is a shock absorber configured to be used for a vehicle. The shock absorber includes a damping force adjustment apparatus. The damping force adjustment apparatus includes a tubular member. The tubular member contains therein a damping force generation unit and a solenoid configured to drive the damping force generation unit. The tubular member includes a first tubular body, a second tubular body arranged outside the first tubular body along an axial direction of the first tubular body, and a crimped portion where the second tubular body is fixed to the first tubular body by being crimped. The crimped portion includes a groove portion provided on an outer peripheral surface of the first tubular body along at least a circumferential part thereof, and an end portion of the second tubular body contained while being bent in the groove portion. The end portion includes a weakened portion less rigid than other portions of the second tubular body.

Another aspect of the present invention is a method for attaching a damping force adjustment apparatus to a shock absorber configured to be used for a vehicle. The method includes a preparation step of preparing a first tubular body including a groove portion on an outer peripheral surface thereof and a second tubular body including a recessed portion where a part of an outer peripheral surface is recessed relative to other portions thereof, a second tubular body attachment step of attaching the second tubular body for containing a damping force generation unit of the damping force adjustment apparatus to an outer peripheral surface of the shock absorber, a damping force generation unit installation step of installing the damping force generation unit into the second tubular body, a first tubular body arrangement step of installing a solenoid for driving the damping force generation unit and arranging the first tubular body inside the second tubular body along an axial direction of the second tubular body after the damping force generation unit installation step, a sandwiching step of engaging a sandwiching member with the recessed portion and sandwiching the second tubular body by the sandwiching member from a radial direction after the first tubular body arrangement step, and a crimping step of crimping the second tubular body toward the first tubular body while moving a tool toward an opening end of the second tubular body along the axial direction after the sandwiching step.

According to the aspects of the present invention, the shock absorber and the method for attaching the damping force adjustment apparatus allow the tubular body to be crimped with improved flexibility.

### BRIEF DESCRIPTION OF DRAWINGS

FIG. 1 is a vertical cross-sectional view of a shock absorber according to a first embodiment.

FIG. 2 is an enlarged view of a damping force adjustment apparatus illustrated in FIG. 1.

FIG. 3 illustrates the first embodiment for facilitating a better understanding of the shape of an end portion of a valve case before crimping.

FIG. 4 illustrates the first embodiment for facilitating a better understanding of a slit formed at the end portion of the valve case.

FIG. 5 illustrates a method for attaching the damping force adjustment apparatus according to the first embodiment.

FIG. 6 illustrates another configuration of the first embodiment, and illustrates a general concept of the valve case.

FIG. 7 illustrates the valve case as viewed from arrows A and A in FIG. 6.

FIG. 8 illustrates a method for attaching the damping force adjustment apparatus according to a second embodiment.

FIG. 9 illustrates another configuration of the second embodiment.

### DESCRIPTION OF EMBODIMENTS

### First Embodiment

A first embodiment of the present invention will be described with reference to the attached drawings.

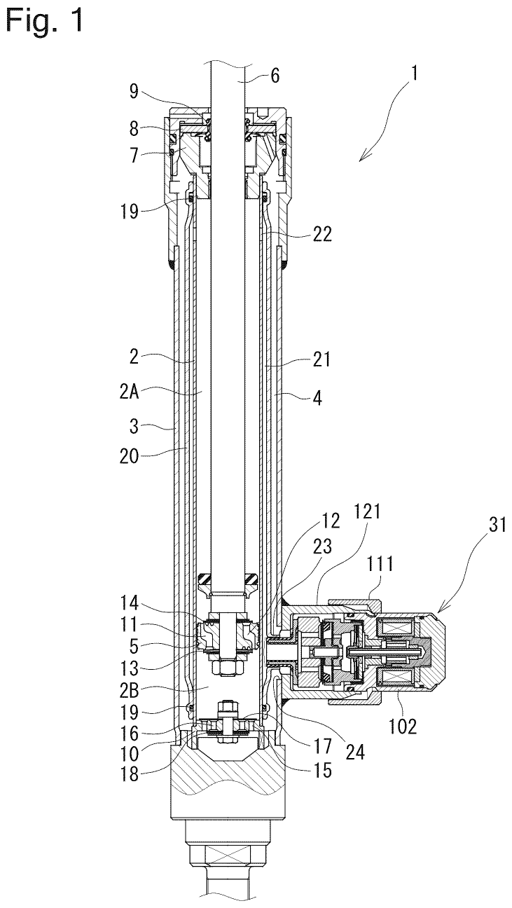

A shock absorber 1 is installed in a suspension apparatus of a vehicle (not illustrated). The shock absorber 1 illustrated in FIG. 1 is a so-called control valve side-mounting damping force adjustable hydraulic shock absorber in which a damping force adjustment apparatus 31 is attached to the sidewall of an outer tube 3 (an outer cylinder) alongside. For the sake of convenience, the vertical direction as viewed in FIG. 1 will be referred to as a “vertical direction” herein.

The shock absorber 1 has a twin-tube structure including a cylinder 2 provided inside the outer tube 3, and a reservoir 4 is defined between the cylinder 2 and the outer tube 3. A piston 5 is slidably fitted in the cylinder 2. The piston 5 partitions the inside of the cylinder 2 into two chambers, a cylinder upper chamber 2A and a cylinder lower chamber 2B. The shock absorber 1 includes a piston rod 6. The lower end side of the piston rod 6 is coupled with the piston 5, and the upper end side of the piston rod 6 is inserted through the cylinder upper chamber 2A and protrudes out of the cylinder 2. The piston rod 6 is inserted through a rod guide 7 fittedly attached to the upper end portion of the cylinder 2. An oil seal 9 attached to a washer 8 seals between the cylinder upper chamber 2A and the outside.

An extension-side passage 11 and a compression-side passage 12 are provided on the piston 5. The extension-side passage 11 and the compression-side passage 12 establish communication between the cylinder upper chamber 2A and the cylinder lower chamber 2B. A disk valve 13 is provided on the extension-side passage 11. When a pressure on the cylinder upper chamber 2A side reaches a set pressure, the disk valve 13 is opened and releases the pressure on the cylinder upper chamber 2A side toward the cylinder lower chamber 2B side. A check valve 14 is provided on the compression-side passage 12. The check valve 14 permits a flow of hydraulic fluid from the cylinder lower chamber 2B toward the cylinder upper chamber 2A.

A base valve 10 is provided at the lower end portion of the cylinder 2. The base valve 10 divides the cylinder lower chamber 2B and the reservoir 4 from each other. An extension-side passage 15 and a compression-side passage 16 are provided on the base valve 10. The extension-side passage 15 and the compression-side passage 16 establish communication between the cylinder lower chamber 2B and the reservoir 4. A check valve 17 is provided on the extension-side passage 15. The check valve 17 permits a flow of the hydraulic fluid from the reservoir 4 side toward the cylinder lower chamber 2B side. A disk valve 18 is provided on the compression-side passage 16. When a pressure on the cylinder lower chamber 2B side reaches a set pressure, the disk valve 18 is opened and releases the pressure on the cylinder lower chamber B side toward the reservoir 4 side. As the hydraulic fluid, oil fluid is sealingly contained in the cylinder 2, and oil fluid and gas are sealingly contained in the reservoir 4.

A separator tube 20 is attached on the outer periphery of the cylinder 2 via a pair of upper and lower seal members 19 and 19. An annular oil passage 21 is defined between the cylinder 2 and the separator tube 20. A passage 22 is provided on the sidewall of an upper portion of the cylinder 2. The passage 22 establishes communication between the annular oil passage 21 and the cylinder upper chamber 2A. A cylindrical connection port 23 is provided on the sidewall of a lower portion of the separator tube 20. The connection port 23 protrudes rightward as viewed in FIG. 1 (outward in the radial direction of the cylinder). An attachment hole 24 is provided on the sidewall of the outer tube 3 coaxially with the connection port 23. A cylindrical valve case 121 (a first tubular body) is provided to the sidewall of the outer tube 3 so as to surround the attachment hole 24.

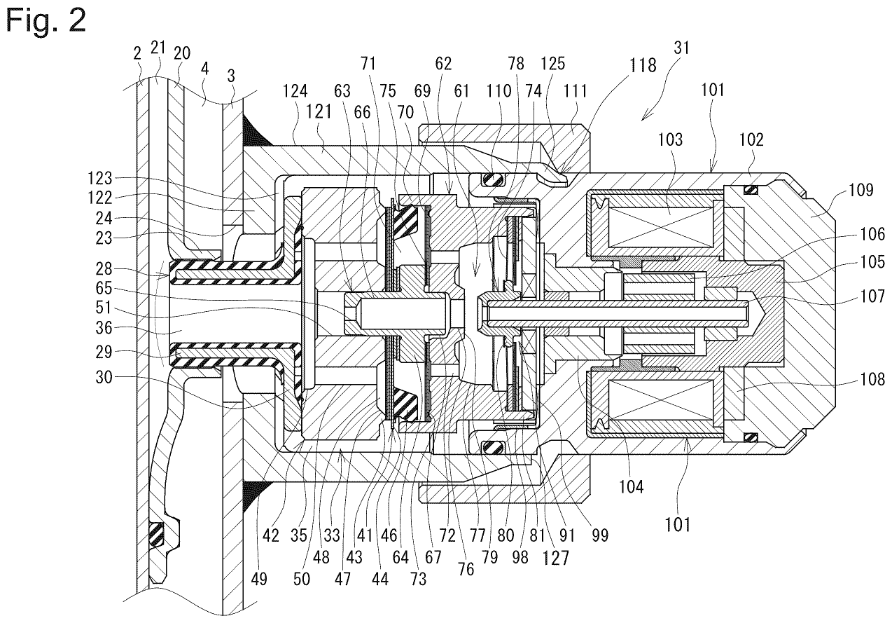

As illustrated in FIG. 2, the damping force adjustment apparatus 31 is contained in the valve case 121. The damping force adjustment apparatus 31 includes a valve block 33 (a damping force generation unit) and a solenoid block 101 (a solenoid). Valve components are integrated in the valve block 33. Solenoid components are integrated in the solenoid block 101. The valve block 33 includes a backpressure-type main valve 41, a pilot valve 61, and a fail-safe valve 91. The pilot valve 61 controls the valve-opening pressure of the main valve 41. The fail-safe valve 91 is provided downstream of the pilot valve 61.

A joint member 28 is inserted through the attachment hole 24 of the outer tube 3. The joint member 28 includes a cylindrical tubular portion 29 and a flange portion 30 (an outer flange). The end portion of the tubular portion 29 on the left side as viewed in FIG. 2 is inserted in the connection port 23. The flange portion 30 is provided on the peripheral edge of the opening of the tubular portion 29 on the right side as viewed in FIG. 2, and is contained in the valve case 121. The tubular portion 29 and the flange portion 30 are covered with a seal member. The end surface of the flange portion 30 on the left side as viewed in FIG. 2 (the inner side in the radial direction of the cylinder) is in abutment with the end surface of an inner flange portion 122 of the valve case 121 on the right side as viewed in FIG. 2 (the outer side in the radial direction of the cylinder), and the end surface of the flange portion 30 on the right side as viewed in FIG. 2 is in abutment with an annular end surface (not labeled) of a main body 42 on the left side as viewed in FIG. 2. A flow passage 35 on the outer periphery of the valve block 33 and the reservoir 4 are in communication with each other via a plurality of grooves 123 provided on the inner flange portion 122 of the valve case 121.

The valve block 33 includes the annular main body 42, an annular pilot body 62, and a pilot pin 63. The pilot pin 63 connects the main body 42 and the pilot body 62. An annular seat portion 43 is formed on the outer peripheral edge portion of the end surface of the main body 42 on the right side as viewed in FIG. 2. The outer peripheral edge portion of the main disk 44 is in abutment with the seat portion 43 in a seatable and separable manner.

The inner peripheral portion of the main disk 44 is clamped between an inner peripheral portion 45 of the main body 42 and a large-diameter portion 64 of the pilot pin 63. An annular packing 46 is provided on the outer peripheral portion of the main disk 44 on the right side as viewed in FIG. 2. An annular recessed portion 47 is provided on the end surface of the main body 42 on the right side as viewed in FIG. 2. An annular passage 48 is defined between the main body 42 and the main disk 44 by the main disk 44 being seated on the seat portion 43. The annular passage 48 is in communication with the flow passage 35 defined on the outer periphery of the main body 42 via an orifice (not labeled) formed on the main disk 44. A recessed portion 49 is formed at the center of the end surface of the main body 42 on the left side as viewed in FIG. 2. The recessed portion 49 and the annular recessed portion 47 (the annular passage 48) are in communication with each other via a plurality of passages 50 (only “two passages” illustrated in FIG. 2) formed on the main body 42.

The pilot pin 63 is formed into a bottomed cylindrical shape opened on the right side as viewed in FIG. 2. An introduction orifice 65 is formed at the bottom portion of the pilot pin 63 on the left side as viewed in FIG. 2. The left side of the pilot pin 63 as viewed in FIG. 2 is press-fitted in an axial hole 51 of the main body 42. The right side of the pilot pin 63 as viewed in FIG. 2 is press-fitted in an axial hole 66 of the pilot body 62. A plurality of grooves extending axially (“horizontally” as viewed in FIG. 2) is formed on the outer peripheral surface of the pilot pin 63 on the right side as viewed in FIG. 2, by which a plurality of passages 67 (only “one passage” illustrated in FIG. 2) is defined between the pilot body 62 and the pilot pin 63.

The pilot body 62 is formed into a generally bottomed cylindrical shape opened on the right side as viewed in FIG. 2. A flexible disk 69 is provided on the left side of the pilot body 62 as viewed in FIG. 2. The flexible disk 69 is clamped by the inner peripheral portion of the pilot body 62 and the large-diameter portion 64 of the pilot pin 63. A cylindrical portion 70 coaxial with the pilot body 62 is formed on the outer peripheral portion of the pilot body 62 on the left side as viewed in FIG. 2. The packing 46 of the main valve 41 is in slidable abutment with the inner peripheral surface of the cylindrical portion 70. Due to that, a pilot chamber 71 is defined on the right side (the back surface) of the main disk 44 as viewed in FIG. 2. The pressure in the pilot chamber 71 is applied to the main disk 44 in a valve-closing direction (a direction for pressing the main disk 44 against the seat portion 43).

A plurality of axially extending passages 72 (only “two passages” illustrated in FIG. 2) is formed on the bottom portion of the pilot body 62 at circumferentially even intervals. An annular passage (not labeled) is formed on the inner side (the inner periphery) of a seat portion 73 by the flexible disk 69 being seated on the annular seat portion 73 provided on the end surface of the pilot body 62 on the left side as viewed in FIG. 2. The left sides of the passages 72 as viewed in FIG. 2 are opened to the annular passage formed on the inner side of the seat portion 73. The flexible disk 69 endows volume elasticity to the pilot chamber 71 by being deflected under the inner pressure in the pilot chamber 71.

The flexible disk 69 is formed by stacking a plurality of disks. A cutout 75 is provided on the inner peripheral portion of a disk in abutment with the large-diameter portion 64 of the pilot pin 63. The cutout 75 establishes communication between the passages 67 and the pilot chamber 71. Due to that, the oil fluid in the annular oil passage 21 is introduced into the damping force adjustment apparatus 31 via a flow passage 36 (an axial hole) of the joint member 28, and is introduced into the pilot chamber 71 via an introduction passage, i.e., the introduction orifice 65, an axial hole 76 of the pilot pin 63, the passages 67, and the cutout 75.

A recessed portion 77 is formed on the right side of the pilot body 62 as viewed in FIG. 2. An annular seat portion 79 (a valve seat) is provided on the bottom portion of the recessed portion 77. A valve body 78 is in abutment with the seat portion 79 in a seatable and separable manner. The seat portion 79 is provided on the circumferential edge of the opening of the axial hole 66 of the pilot body 62, through which the hydraulic fluid passes. The valve body 78 is generally cylindrically formed, and the end portion thereof on the left side as viewed in FIG. 2 is formed in a tapered manner. A flange portion 80 shaped as an outer flange is provided on the right side of the valve body 78 as viewed in FIG. 2. The valve body 78 is biased by a pilot spring 74 in a direction away from the seat portion 79 (rightward as viewed in FIG. 2).

A cylindrical portion 81 is formed on the right side of the pilot body 62 as viewed in FIG. 2. Stacked components including the pilot spring 74, a fail-safe disk 94, a retainer, a spacer, a washer, and the like are provided in the cylindrical portion 81. These stacked components are fixed by a cap 98 fittedly attached to the outer periphery of the cylindrical portion 81. A passage 99 is defined between the cap 98 and the cylindrical portion 81 of the pilot body 62. The passage 99 establishes communication between the recessed portion 77 (a valve chamber) and the flow passage 35 defined on the outer periphery of the valve block 33.

The solenoid block 101 is constructed by assembling and integrating a coil 103, a core 104, a core 105, a plunger 106, and a hollow actuation rod 107 coupled with the plunger 106 in the solenoid case 102 (the first tubular body). A spacer 108 and a cover 109 are inserted in the solenoid case 102 on the right side as viewed in FIG. 2. An axial force is applied to the components in the solenoid case 102 by applying plastic working on the edge portion of the end of the solenoid case 102 on the right side as viewed in FIG. 2. The plunger 106 generates a thrust force according to a current value by electric power supply to the coil 103. The thrust force generated by the plunger 106 works so as to move the valve body 78 in a direction toward the seat portion 79 (leftward as viewed in FIG. 2) against the biasing force of the pilot spring 74.

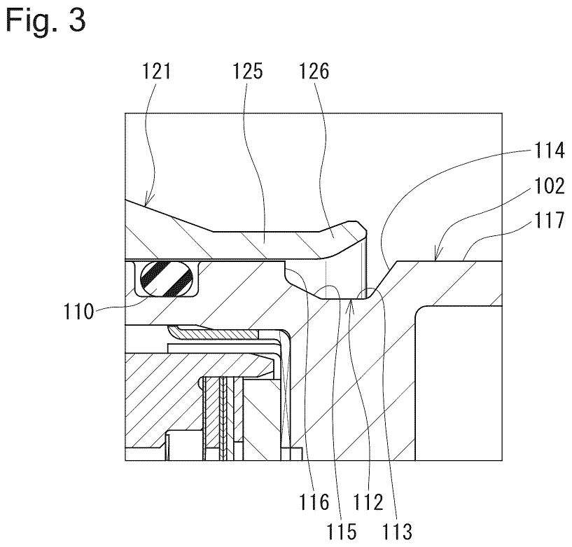

The end portion of the solenoid case 102 on the left side as viewed in FIG. 2 is inserted in the opening of the valve case 121 on the right side as viewed in FIG. 2. A seal member 110 seals between the solenoid case 102 and the valve case 121. The left side of the actuation rod 107 as viewed in FIG. 2 protrudes into the recessed portion 77 (the valve chamber). The valve body 78 is attached to the end portion of the actuation rod 107 on the left side as viewed in FIG. 2. In the first embodiment, crimping the valve case 121 (a second tubular body) toward the solenoid case 102 (the first tubular body) causes the solenoid case 102 and the valve case 121 to be fixed to each other to form a tubular member 100 in which the solenoid case 102 and the valve case 121 are integrated, and the valve block 33 and the solenoid block 101 to be also joined (integrated) with each other. A crimped portion 118 (refer to FIG. 3) between the solenoid case 102 and the valve case 121 is covered with a tubular cover 111 (a cover member).

Then, when no electric power is supplied to the coil 103 illustrated in FIG. 2, the valve body 78 is biased by the pilot spring 74 in a direction away from the seat portion 78, and the flange portion 80 of the valve body 78 is placed into abutment with (seated on) the fail-safe disk 94. On the other hand, when electric power is supplied to the coil 103, a thrust force leftward as viewed in FIG. 2 is generated on the plunger 106 to move the actuation rod 107 leftward as viewed in FIG. 2 against the biasing force of the pilot spring 74, thereby causing the valve body 78 to be seated onto the seat portion 79. The valve-opening pressure of the valve body 78 is controlled by changing a current value of the electric power supplied to the coil 103. At the time of a soft mode where electric power of a low current value is supplied to the coil 103, the pilot valve 61 is opened by a predetermined valve lift (a valve lift at the time of a soft characteristic) due to equilibrium established between the biasing force of the pilot spring 74 and the thrust force of the plunger 106.

During an extension stroke of the piston rod 6, in the shock absorber 1, the check valve 14 of the piston 5 is closed due to an increase in the pressure in the cylinder upper chamber 2A, and the hydraulic fluid on the cylinder upper chamber 2A side is pressurized before the disk valve 13 is opened. The pressurized hydraulic fluid passes through the passage 22 and the annular passage 21, and is introduced from the connection port 23 of the separator tube 20 into the damping force adjustment apparatus 31 via the joint member 28. At this time, the hydraulic fluid flows from the reservoir 4 into the cylinder lower chamber 2B by an amount corresponding to the movement of the piston 5 by opening the check valve 17 of the base valve 10. When the pressure in the cylinder upper chamber 2A reaches the valve-opening pressure of the disk valve 13 of the piston 5 to open the disk valve 13, the pressure in the cylinder upper chamber 2A is relieved into the cylinder lower chamber 2B. As a result, an excessive increase in the pressure in the cylinder upper chamber 2A is avoided.

On the other hand, during a compression stroke of the piston rod 6, the check valve 14 of the piston 5 is opened due to an increase in the pressure in the cylinder lower chamber 2B, and the check valve 17 of the extension-side passage 15 of the base valve 10 is closed. Before the disk valve 18 is opened, the hydraulic fluid in the piston lower chamber 2B flows into the cylinder upper chamber 2A, and the hydraulic fluid is introduced by a volume corresponding to the entry of the piston rod 6 into the cylinder 2 from the cylinder upper chamber 2A into the damping force adjustment apparatus 31 by passing through the passage 22, the annular flow passage 21, the connection port 23 of the separator tube 20, and the flow passage 36 of the joint member 28. When the pressure in the cylinder lower chamber 2B reaches the valve-opening pressure of the disk valve 18 of the piston 10 to open the disk valve 18, the pressure in the cylinder lower chamber 2B is relieved into the reservoir 4. As a result, an excessive increase in the pressure in the cylinder lower chamber 2B is avoided.

The hydraulic fluid introduced in the damping force adjustment apparatus 31 is delivered into the pilot chamber 71 via the introduction orifice 65 of the pilot pin 63, the axial hole 76, the recessed portion 77 of the pilot body 62, the passages 72, and the flexible disk 69. Before the main valve 41 is opened (when the piston speed is in a low speed region), the hydraulic fluid delivered in the recessed portion 77 flows into the reservoir 4 via the pilot spring 74, the axial hole of the fail-safe disk 94, the passage 99 between the cap 98 and the pilot body 62, the flow passage 35 on the outer periphery of the valve block 33, and the plurality of grooves 123 formed on the inner flange portion 122 of the valve case 121.

When the piston speed increases and the pressure of the hydraulic fluid introduced in the annular passage 48 via the annular oil passage 21, the flow passage 36 of the joint member 28, and the passages 50 of the main body 42 reaches the valve-opening pressure of the main valve 41 to open the main valve 41, the hydraulic fluid in the annular passage 48 flows into the reservoir 4 by passing through the flow passage 35 on the outer periphery of the valve block 33 and the plurality of grooves 123 formed on the inner flange portion 122 of the valve case 121.

In this manner, the damping force adjustment apparatus 31 generates a damping force due to the hydraulic fluid passing through the introduction orifice 65 and the pilot valve 61 before the main valve 41 is opened (when the piston speed is in the low speed region) during both the extension stroke and the compression stroke of the piston rod 6. Further, the damping force adjustment apparatus 31 generates a damping force according to the valve lift of the main valve 41 after the main valve 41 is opened (when the piston speed is in an intermediate speed region). Then, the damping force generated by the damping force adjustment apparatus 31 can be directly controlled by controlling the electric power supply to the coil 103 to adjust the valve-opening pressure of the pilot valve 61.

Further, when the thrust force of the plunger 106 is lost at the time of the occurrence of a failure such as a disconnection of the coil 103 or a malfunction of an in-vehicle controller, the valve body 78 is moved in a direction opposite from the cylinder with the aid of the biasing force of the pilot spring 74 (which also serves as a fail-safe spring), by which the pilot valve 61 is opened. Along therewith, the flange portion 80 of the valve body 78 is placed into abutment with the fail-safe disk 94, by which the communication is blocked between the inner flow passage (not labeled) and the outer flow passage 35 of the valve block 33.

This allows a predetermined damping force to be generated when a failure occurs by adjusting the valve-opening pressure of the fail-safe valve 91 and controlling the flow of the hydraulic fluid flowing from the annular oil passage 21 into the reservoir 4 via the flow passage 36 of the joint member 28, the introduction orifice 65 of the pilot pin 63, the axial hole 76, the recessed portion 77 of the pilot body 62, the passage 99 between the cap 98 and the pilot body 62, the flow passage 35 on the outer periphery of the valve block 33, and the plurality of grooves 123 formed on the inner flange portion 122 of the valve case 121. At the same time, the inner pressure in the pilot chamber 71 and thus the valve-opening pressure of the main valve 41 can be adjusted, and a predetermined damping force can be acquired even when a failure occurs.

Then, FIG. 3 illustrates a state when the solenoid case 102 (the first tubular body) is arranged inside the valve case 121 (the second tubular body) along the axial direction of this valve case 121 (arranged coaxially) and before an opened end portion 125 of the valve case 121 on the right side as viewed in FIG. 3 (the outer side in the radial direction of the cylinder) is crimped. Internal components 32 are contained in the valve case 121.

As illustrated in FIG. 3, the end portion 125 of the valve case 121 is formed to have a smaller outer diameter than the other portions (the left-side portion as viewed in FIG. 3, i.e., the inner portion in the radial direction of the cylinder). In other words, the end portion 125 of the valve case 121 is formed to have a thinner thickness than the other portions. An enlarged-diameter portion 126 is provided on the edge portion of the opening of the end portion 125 of the valve case 121. The enlarged-diameter portion 126 increases in diameter so as to be inclined outward in the radial direction of the valve case 121 (“upward” as viewed in FIG. 3) toward the opening end of the valve case 121.

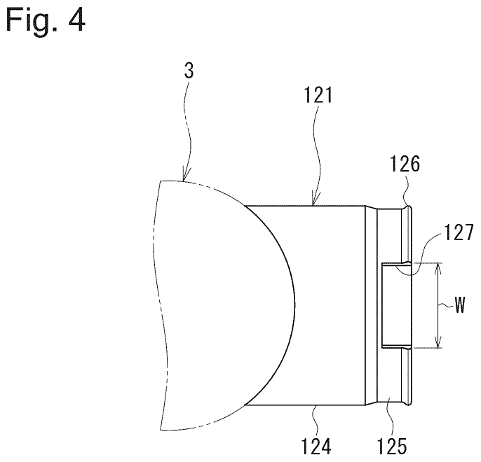

As illustrated in FIG. 4, a slit 127 (a weakened portion) is provided on the end portion 125 of the valve case 121. The slit 127 extends from the opening end of the valve case 121 (the enlarged-diameter portion 126) leftward as viewed in FIG. 4 (inward in the radial direction of the cylinder) along the axial direction of the valve case 121 while maintaining a predetermined width W. The provision of this slit 127 lowers the rigidity of the end portion 125, thereby allowing the end portion 125 of the valve case 121 to be bent inward in the radial direction of the valve case 121 (“downward” as viewed in FIG. 3) with a further weak crimping force when the end portion 125 of the valve case 121 is crimped.

As illustrated in FIG. 3, an annular crimping groove 112 (a groove portion) is provided on an outer peripheral surface 117 of the solenoid case 102. The crimping groove 112 receives the end portion 125 of the valve case 121 that is bent by being crimped. The crimping groove 112 includes a bottom portion 113, a tapered portion 114, a tapered portion 115, and a flange surface 116. The bottom portion 113 has a predetermined outer diameter. The tapered portion 114 increases in diameter from the end of this bottom portion 113 on the right side as viewed in FIG. 3 to the right side as viewed in FIG. 3 (to the outer side in the radial direction of the cylinder). The tapered portion 115 increases in diameter from the end of this bottom portion 113 on the left side as viewed in FIG. 3 to the left side as viewed in FIG. 3 (to the inner side in the radial direction of the cylinder). The flange surface 116 is provided between this tapered portion 115 and the outer peripheral surface 117. The crimping groove 112 does not have to be formed annularly, i.e., formed over the entire circumference of the outer peripheral surface 117, and may be formed by intermittently providing a plurality of grooves.

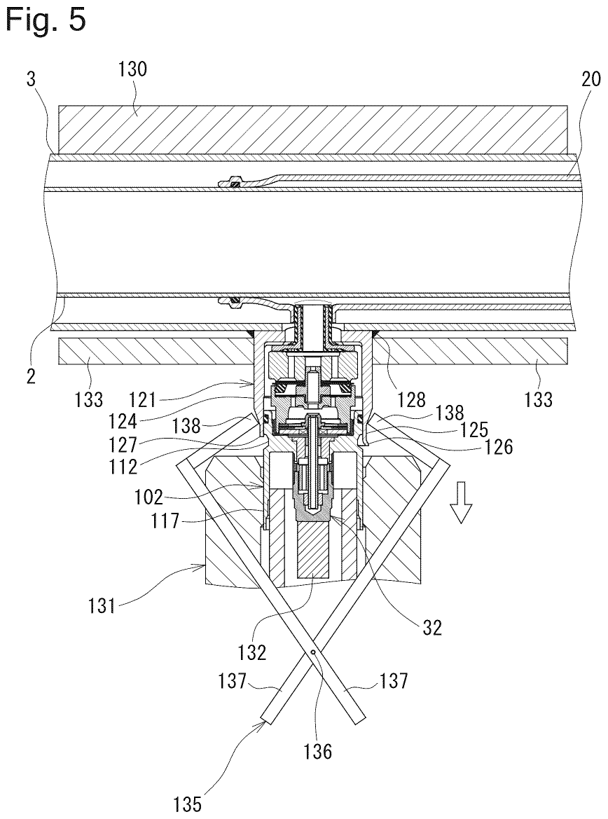

Next, a method for attaching the damping force adjustment apparatus 31 according to the first embodiment will be described with reference to FIG. 5.

### Preparation Step

First, the solenoid case 102 (the first tubular body) and the valve case 121 (the second tubular body) are prepared.

### Second Tubular Body Attachment Step

Next, the valve case 121 is joined to the outer tube 3 (the outer cylinder) by welding (fillet welding). As a result, a bead 128 generally shaped like an isosceles triangle in cross section is formed along the ridge between the valve case 121 and the outer tube 3.

### Damping Force Generation Unit Installation Step

Next, the valve block 33 (a damping force generation unit) of the damping force adjustment apparatus 31 is installed into the valve case 121.

### First Tubular Body Arrangement Step

After the valve block 33 is installed in the valve case 121, the solenoid block 101 (portions other than the coil 103 and the like) is assembled to the valve block 33. Next, the end portion of the solenoid case 102 on the inner side in the radial direction of the cylinder (the “upper side” as viewed in FIG. 5) is inserted into the end portion 125 of the valve case 121. As a result, the solenoid case 102 is arranged coaxially with the valve case 121 (along the axial direction of the valve case 121).

### Sandwiching Step

Next, as illustrated in FIG. 5, the sidewall of the outer tube 3 opposite from where the valve case 121 is fixed is supported by a support member 130, and the cylindrical portion (a portion containing the coil 103) of the solenoid case 102 is also supported by a guide member 131. The internal components 32 (the valve block 33 and the solenoid block 101) in the tubular member where the solenoid case 102 and the valve case 121 are integrated are pressed in this state in the radial direction of the cylinder toward the support member 130 (“upward” as viewed in FIG. 5) using a pressing member 132, by which an axial force is applied to the internal components 32. Further, the outer peripheral surface 124 of the valve case 121 is sandwiched by a pair of sandwiching members 133 and 133 in the radial direction of the valve case 121 with the solenoid case 102 overlapping the valve case 121 coaxially and by an amount corresponding to a crimping margin.

### Crimping Step

Next, the crimped portion 118 (refer to FIG. 3) is formed at the portion where the solenoid case 102 and the valve case 121 overlap each other by crimping the end portion 125 of the valve case 121 using a crimping tool 135. Now, the tool 135 includes a pair of rod-like link portions 137 and 137 and pressing portions 138 and 138. The link portions 137 and 137 are relatively rotatable about a hinge 136 (a fulcrum). The pressing portions 138 and 138 are arranged at respective one ends of the link portions 137 and 137 so as to be located opposite from each other. The link portion 137 and the pressing portion 138 define an L-like shape.

Then, in the crimping step, applying a pressure in a direction for closing the other end portions (an effort) of the link portions 137 and 137 of the crimping tool 135 causes the end portion 125 of the valve case 121 to be bent (inclined) toward the crimping groove 112 (the groove portion) of the solenoid case 102 by the tips (a load) of the pressing portions 138 and 138 of the crimping tool 135. At this time, the end portion 125 of the valve case 121 is pressed while the crimping tool 135 is moved at a constant speed in the axial direction of the solenoid case 102 and the valve case 121 (the tubular member) and a direction away from the outer tube 3 (“downward” as viewed in FIG. 5 and a direction toward the opening end of the second tubular body).

The crimping tool 135 is illustrated in FIG. 5 as if one of the pressing portions 138 and 138 thereof (the pressing portion 138 on the left side as viewed in FIG. 5) presses a portion of the end portion 125 of the valve case 121 where the slit 127 is formed for the sake of convenience, but, actually, both the pressing portions 138 and 138 press other portions of the end portion 125 of the valve case 121 (portions where the slid 127 is not formed).

Now, conventionally, to ensure joining strength (strength against separation) between the valve case and the solenoid case, a strong crimping force corresponding to this strength has been required. This has resulted in an increase in the load imposed on the outer tube (the outer cylinder) and thus deformation of the outer tube.

On the other hand, the first embodiment lowers the rigidity of the end portion 125 of the valve case 121 by forming the slit 127 (the weakened portion) on the end portion 125 of the valve case 121 (the second tubular body), thereby allowing the end portion 125 of the valve case 121 to be crimped with a further weak crimping force, i.e., bent with a further weak pressing force, thus allowing the tubular body (the valve case 121) to be crimped with improved flexibility. Due to that, the first embodiment can reduce the load imposed on the outer tube 3, thereby preventing the deformation of the outer tube 3.

Further, the first embodiment lowers the rigidity of the end portion 125 of the valve case 121 with the aid of the slit 127, thereby eliminating the necessity of an increase in the plate thickness of the outer tube 3 so as to allow it to tolerate a strong crimping force, thus succeeding in preventing an increase in the thickness of the outer tube 3 and thus an increase in the weight of the shock absorber 1.

The first embodiment provides the enlarged-diameter portion 12, which is inclined outward in the radial direction of the valve case 121 toward the opening end of the valve case 121, on the edge portion of the opening of the end portion 125 of the valve case 125 in a state before the crimping, thereby facilitating centering of the solenoid case 102 (the first tubular body) in relation to the valve case 121 (the second tubular body) in the above-described first tubular body arrangement step.

Further, the provision of the enlarged-diameter portion 126 on the end portion 125 of the valve case 121 allows the seal member 110 (an O-ring) attached to the solenoid case 121 to be prevented from incurring damage when the solenoid case 102 is inserted into the valve case 121, thereby contributing to preventing the occurrence of contamination and improving the reliability of the shock absorber 1.

The first embodiment causes the crimping tool 135 to press the end portion 125 of the valve case 121 while moving at a constant speed in the axial direction of the solenoid case 102 and the valve case 121 (the tubular member) and the direction away from the outer tube 3 in the above-described crimping step, thereby allowing the crimping force applied to the outer tube 3 (a force working so as to deform the cross-sectional shape of the outer tube 3) to be released and thus contributing to further reliably preventing the deformation of the outer tube 3.

The first embodiment includes the slit 127 (the weakened portion) extending from the opening end of the valve case 121 toward the outer tube 3 in the axial direction of the valve case 121, thereby, for example, allowing water introduced in the cover 111 (a cover member) to be discharged out of the cover 111 via the slit 127 with the aid of the arrangement of at least one slit 127 (only one slit 127 in the first embodiment) in a semi-perimeter region of the end portion 125 of the valve case 121 on a closer side to the road surface in a state that the shock absorber 1 is mounted on the vehicle, thus contributing to improving the capability of removing the water inside the cover 111.

The first embodiment is not limited to the above-described configuration, and, for example, can be configured in the following manner.

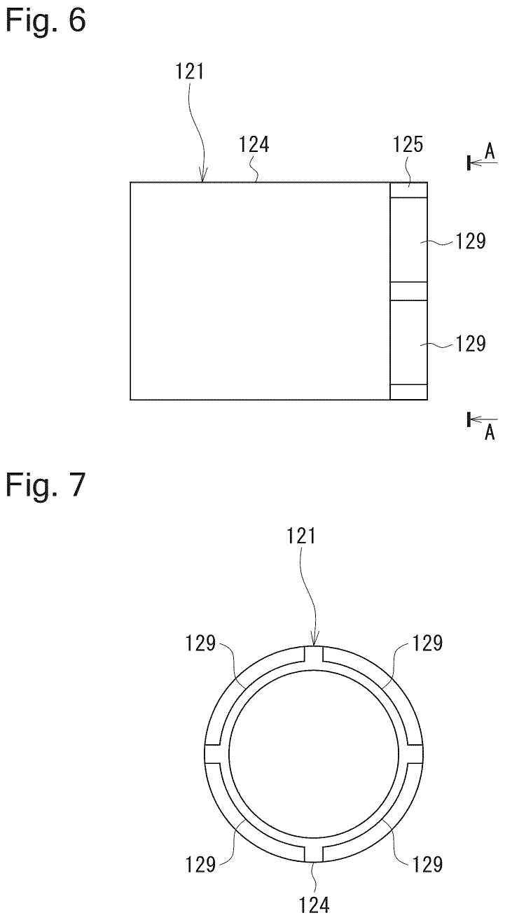

The first embodiment is configured to lower the rigidity (bending strength) of the end portion 125 of the valve case 121 by providing the end portion 125 of the valve case 121 with the slit 127 (the weakened portion), which extends from the opening end of the valve case 121 along the axial direction of the valve case 121 while maintaining the predetermined width W. On the other hand, the rigidity (bending strength) of the end portion 125 of the valve case 121 may be lowered by providing the outer peripheral surface of the end portion 125 of the valve case 121 with a plurality of (“four” exemplarily illustrated in FIGS. 6 and 7) recessed portions 129 (the weakened portion), which extends from the opening end of this end portion 125 axially (“leftward” as viewed in FIG. 6), at even intervals in the circumferential direction of the valve case 121 as illustrated in FIGS. 6 and 7, instead of providing the slit 127.

### Second Embodiment

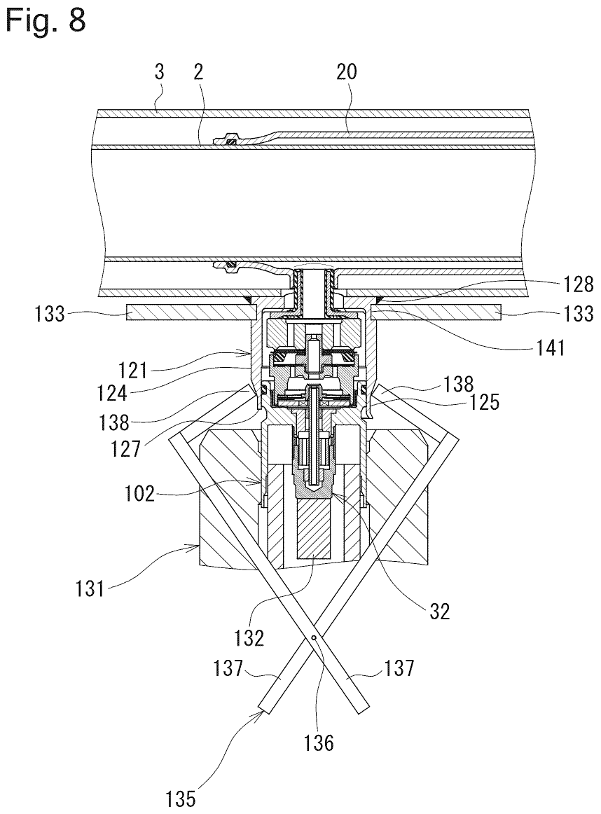

Next, a second embodiment will be described with reference to FIG. 8. The second embodiment will be described here, focusing on differences from the first embodiment. The second embodiment will be described, assigning the same names and reference numerals to portions shared with the first embodiment, and omitting redundant descriptions thereof.

The first embodiment is configured to sandwich the outer peripheral surface 124 of the valve case 121 (the first tubular body) by the pair of sandwiching members 133 and 133 in the radial direction of the valve case 121 to axially guide it in the sandwiching step in the method for attaching the damping force adjustment apparatus 31. Further, in the first embodiment, the pressing force by the pressing member 132 (the axial force of the internal components 32) and the axial component of the crimping force applied to the valve case 121 (the force working so as to press the valve case 121 against the outer tube 3 (the outer cylinder)) are received by the support member 130 placed in abutment with the sidewall of the outer tube 3 opposite from where the valve case 121 is fixed.

On the other hand, the second embodiment is configured in such a manner that a width-across-flats portion 141 (a recessed portion recessed relative to the other portions of the outer peripheral surface 124), which has a predetermined width (a width corresponding to the plate thickness of the sandwiching member 133) in the axial direction, is provided on the outer peripheral surface 124 of the valve case 121, and the pair of sandwiching members 133 and 133 is engaged (hooked) with the width-across-flats portion 141 in the sandwiching step.

According to the second embodiment, the force received by the outer tube 3 (the support member 130) in the first embodiment, i.e., the pressing force by the pressing member 132 and the axial component of the crimping force applied to the valve case 121 can be received by the pair of sandwiching members 133 and 133, and therefore the deformation of the outer tube 3 can be reliably prevented in the crimping step.

Further, the second embodiment allows the support member 130 to be omitted from the manufacturing facility in the first embodiment, thereby contributing to the simplification of this facility.

The second embodiment is not limited to the above-described configuration, and, for example, can be configured in the following manner.

The width-across-flats portion 141 is provided on the outer peripheral surface 124 of the valve case 121 to form the recessed portion recessed relative to the other portions of the outer peripheral surface 124 in the second embodiment, but, for example, an annular groove (141) may be provided on the outer peripheral surface 124 of the valve case 121 to form the recessed portion.

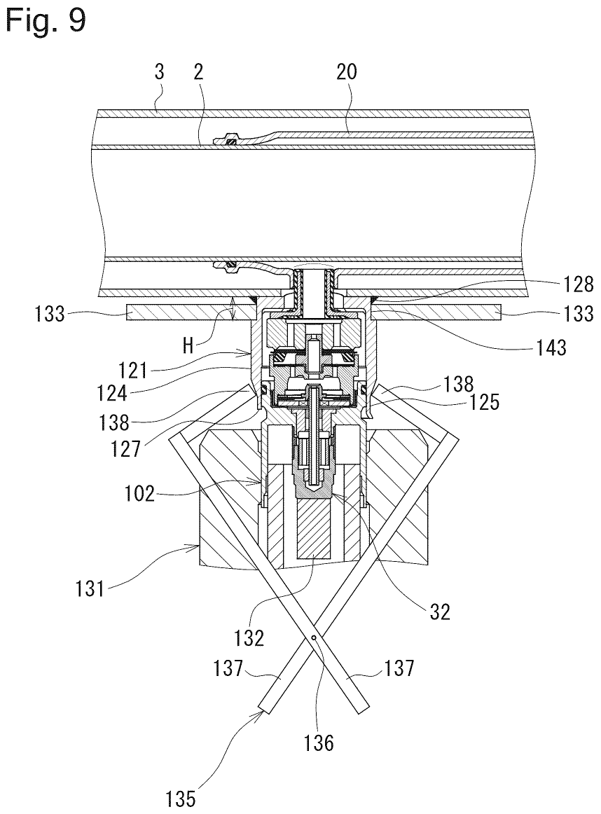

Alternatively, as illustrated in FIG. 9, the shock absorber 1 may be configured in such a manner that a recessed portion 143 (a portion recessed relative to the other portions) is formed at the end portion of the valve case 121 on the outer tube 3 side (the “upper side” as viewed in FIG. 9) so as to circumferentially extend along the ridge between the outer tube 3 and the valve case 121 at a height (an axial length) H from the outer tube 3, causing the bead 128 to be formed by welding the ridge between the recessed portion 143 and the outer tube 3 and allowing the pair of sandwiching members 133 and 133 to be engaged (hooked) with the opposite side (the “lower side” as viewed in FIG. 9) of the recessed portion 143 from the outer tube 3 side in the sandwiching step.

In this case, the welding bead 128 is contained inside the recessed portion 143, and therefore the design quality of the shock absorber 1 can be improved. Further, this configuration can lead to a reduction in the outer diameter of the bead 128, thereby contributing to a reduction in the size of a hole formed on a bracket (not illustrated) for inserting the damping force adjustment apparatus 31 therethrough, improving the rigidity of the bracket and thus the attachment strength of the shock absorber 1.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2022-167233 filed on Oct. 18, 2022. The entire disclosure of Japanese Patent Application No. 2022-167233 filed on Oct. 18, 2022 including the specification, the claims, the drawings, and the abstract is incorporated herein by reference in its entirety.

### REFERENCE SIGNS LIST

1 shock absorber
31 damping force adjustment apparatus
101 solenoid block (solenoid)
102 solenoid case (first tubular body)
112 crimping groove (groove portion)
117 outer peripheral surface (outer peripheral surface of first tubular body)
118 crimped portion
121 valve case (second tubular body)
125 end portion (end portion of first tubular body)

1. A shock absorber configured to be used for a vehicle, the shock absorber comprising:
a damping force adjustment apparatus,
the damping force adjustment apparatus including a tubular member, the tubular member containing therein a damping force generation unit and a solenoid configured to drive the damping force generation unit,
the tubular member including a first tubular body, a second tubular body arranged outside the first tubular body along an axial direction of the first tubular body, and a crimped portion where the second tubular body is fixed to the first tubular body by being crimped,
the crimped portion including a groove portion provided on an outer peripheral surface of the first tubular body along at least a circumferential part thereof, and an end portion of the second tubular body contained while being bent in the groove portion,
the end portion including a weakened portion less rigid than other portions of the second tubular body,
the weakened portion being a plurality of recessed portions axially extending from an opening end of the end portion on an outer peripheral surface of the end portion of the second tubular body.

2. A shock absorber configured to be used for a vehicle, the shock absorber comprising:
a damping force adjustment apparatus,
the damping force adjustment apparatus including a tubular member, the tubular member containing therein a damping force generation unit and a solenoid configured to drive the damping force generation unit,
the tubular member including a first tubular body, a second tubular body arranged outside the first tubular body along an axial direction of the first tubular body, and a crimped portion where the second tubular body is fixed to the first tubular body by being crimped,
the crimped portion including a groove portion provided on an outer peripheral surface of the first tubular body along at least a circumferential part thereof, and an end portion of the second tubular body contained while being bent in the groove portion,
the end portion including a weakened portion less rigid than other portions of the second tubular body,
the weakened portion being at least one slit formed on the end portion and extending in an axial direction of the tubular member.

3. (canceled)

4. The shock absorber according to claim 2, wherein the end portion increases in diameter so as to be inclined outward in a radial direction of the tubular member in a state before the second tubular body is crimped.

5. The shock absorber according to claim 2, wherein the damping force adjustment apparatus further includes a cover member covering an outer peripheral side of the crimped portion, and
wherein the at least one slit is provided at an arbitrary portion of a semi-perimeter of the end portion located on a closer side to a road surface in a state that the shock absorber is mounted on the vehicle.

6. A shock absorber configured to be used for a vehicle, the shock absorber comprising:
a damping force adjustment apparatus configured to be driven by a solenoid,
the damping force adjustment apparatus including a tubular member, the tubular member containing therein a damping force generation unit and the solenoid configured to drive the damping force generation unit,
the tubular member including a first tubular body, and a second tubular body arranged outside the first tubular body along an axial direction of the first tubular body,
the second tubular body including a recessed portion where a part of an outer peripheral surface is recessed relative to other portions thereof, the first tubular body being fixed to the second tubular body.

7. The shock absorber according to claim 6, wherein the damping force adjustment apparatus is attached to an outer tube of the shock absorber by welding,
wherein the recessed portion is provided at a position facing the outer tube, and
wherein a bead of the welding is contained inside the recessed portion.

8. A method for attaching a damping force adjustment apparatus to a shock absorber configured to be used for a vehicle, the method comprising:
a preparation step of preparing a first tubular body including a groove portion on an outer peripheral surface thereof and a second tubular body including a plurality of recessed portions axially extending from an opening end of an end portion on an outer peripheral surface of the end portion of the second tubular body;
a second tubular body attachment step of attaching the second tubular body for containing a damping force generation unit of the damping force adjustment apparatus to an outer peripheral surface of the shock absorber;
a damping force generation unit installation step of installing the damping force generation unit into the second tubular body;
a first tubular body arrangement step of installing a solenoid for driving the damping force generation unit and arranging the first tubular body inside the second tubular body along an axial direction of the second tubular body after the damping force generation unit installation step;
a sandwiching step of engaging a sandwiching member with the recessed portion and sandwiching the second tubular body by the sandwiching member from a radial direction after the first tubular body arrangement step; and
a crimping step of crimping the second tubular body toward the first tubular body while moving a tool toward an opening end of the second tubular body along the axial direction after the sandwiching step.
